(19) United States
(12) Patent Application Publication
(10) Pub. No.: US 2011/0319022 A1
(43) Pub. Date: Dec. 29, 2011

(54) METHOD AND SYSTEM FOR MONITORING AND LOCATING ITEMS

(76) Inventors: Eliahu Arad, Tzofit (IL); Nissim Zur, Givataim (IL)

(21) Appl. No.: 13/131,867

(22) PCT Filed: Dec. 1, 2009
(86) PCT No.: PCT/IL09/01131

§ 371 Date: Sep. 15, 2011

Related U.S. Application Data
(60) Provisional application No. 61/118,666, filed on Dec. 1, 2008.

(51) Int. Cl. H04B 7/00

(52) U.S. Cl. 455/41.2

(57) ABSTRACT

A monitoring system includes a first device and a second device. The first device includes: a first Bluetooth transceiver, for transmitting a first message to a second Bluetooth transceiver, wherein the first message includes a request from the second Bluetooth transceiver to transmit a second message that includes a second message transmission power indicator that is indicative of a transmission power of the second message; and for receiving the second massage by the first Bluetooth transceiver and measuring a reception power of the second message; and a distance calculator for calculating the distance between the first and second Bluetooth transceivers based on a relationship between the transmission power of the second message and the reception power of the second message. The second device includes: a second Bluetooth transceiver, for transmitting the second message to the first Bluetooth transceiver, wherein the second message includes the second message transmission power indicator that is indicative of the transmission power of the second message.

### CROSS REFERENCE TO RELATED APPLICATIONS

This application claims the benefit of U.S. provisional application No. 61/118,666, filed on Dec. 1, 2008 (and entitled “method and system for locating items”).

### BACKGROUND OF THE INVENTION

Locating items such as luggage in an airport, as well as many other known scenarios, is a well known problem. People standing by luggage conveyers, for example, after flights, cruises etc. experience great deal of stress and emotional stress, while waiting and trying to locate and draw their luggage off the conveyers.

The Bluetooth™ chip set includes methods that can retrieve information from a Bluetooth radio modem about the received signal strength.

The CPU_Read RSSI value returns, for a specified Asynchronous Connectionless (ACL) connection, a signed 8-bit integer giving values between −128 and +127. The Bluetooth specification only defines the following details: (i) If the RSSI is within the Golden Receiver Range, RSSI returns zero.

(ii) If the RSSI is below the Golden Receiver Range lower limit, RSSI returns a negative value.

(iii) If the RSSI is above the Golden Receiver Range upper limit, RSSI returns a positive value.

The Golden Receiver Range is the target signal strength at the receiver. If the receiving device supports the optional RSSI feature, and the transmitting device supports Power Control, then the receiving device can send requests to the transmitting device for increments and decrements in the transmitted power, in an attempt to keep the received power within the Golden Range. (See separate information note on Power Control for more detail.) The Golden Receiver Range is 20 dB±6 dB wide. The dynamic range for Transmit Power Control is typically 30 dB. These figures combine to produce an RSSI dead band of 50 dB: RSSI returns a zero whether the devices are far apart transmitting at maximum power with RSSI at the bottom of the Golden Range, or very close but transmitting at minimum power with RSSI at the top of the Golden Range. In other words, in a Power Control link, RSSI can not report the difference between a device that is 10 cm away and one that is 50 m away, and this does not even start to deal with the complications of signal strength nodes and nulls created by multipath interference.

The scale of the positive and negative values returned when RSSI is outside the Golden Receiver Range, is left up to the individual manufacturer, but there is nothing to prevent the returned values being restricted to −1, 0 and +1.

Some hardware may be limited in its ability to measure incoming signal strength and only be capable of recognizing signals within, above or below the golden receiver range. Other hardware may have more accurate measurement, but it is not possible to make much use of the information via the Bluetooth command because of the limits that the specification places on the return parameter and the effects of Transmit Power Control.

In summary, the RSSI is not particularly useful on its own.

The Get_Link_Quality command returns, for a specified ACL connection, an 8-bit unsigned integer, giving values between 0 and 255. The Bluetooth specification provides no guidance as to what this number means beyond “The higher the value, the better the link quality is. Each Bluetooth module vendor will determine how to measure the link quality.”—which is not particularly helpful. It means that for a host to make an intelligent use of the Link Quality information it must understand what the parameter means for the hardware concerned.

### SUMMARY OF THE INVENTION

A method for determining a distance between a pair of Bluetooth transceivers is provided. The method includes: transmitting a first message from a first Bluetooth transceiver to a second Bluetooth transceiver, wherein the first message includes a request from the second Bluetooth transceiver to transmit a second message that includes a second message transmission power indicator that is indicative of a transmission power of the second message; receiving the second massage by the first Bluetooth transceiver and measuring a reception power of the second message; and calculating the distance between the first and second Bluetooth transceivers based on a relationship between the transmission power of the second message and the reception power of the second message.

A monitoring device that includes: a first Bluetooth transceiver, for transmitting a first message to a second Bluetooth transceiver, wherein the first message includes a request from the second Bluetooth transceiver to transmit a second message that includes a second message transmission power indicator that is indicative of a transmission power of the second message; and for receiving the second massage by the first Bluetooth transceiver and measuring a reception power of the second message; and a distance calculator for calculating the distance between the first and second Bluetooth transceivers based on a relationship between the transmission power of the second message and the reception power of the second message.

A system that includes a first device and a second device; wherein the first device includes: a first Bluetooth transceiver, for transmitting a first message to a second Bluetooth transceiver, wherein the first message includes a request from the second Bluetooth transceiver to transmit a second message that includes a second message transmission power indicator that is indicative of a transmission power of the second message; and for receiving the second massage by the first Bluetooth transceiver and measuring a reception power of the second message; and a distance calculator for calculating the distance between the first and second Bluetooth transceivers based on a relationship between the transmission power of the second message and the reception power of the second message; wherein the second device includes: a second Bluetooth transceiver, for transmitting the second message to the first Bluetooth transceiver, wherein the second message includes the second message transmission power indicator that is indicative of the transmission power of the second message.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A is a block diagram of a monitoring device and a monitored device according to an embodiment of the invention;

FIGS. 1B and 1C illustrate an example of a panel of a monitoring device according to some embodiment of the invention;

FIGS. 2A and 2B are flow-charts of a method for a distance determination according to an embodiment of the invention;

FIGS. 3A, 3B and 3C illustrate messages of a unique protocol according to an embodiment of the invention; and

FIG. 4 illustrates protocol layers and messages between the protocol layers, according to an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

A system and a method for determining a distance between a pair of Bluetooth devices is provided. The system and method can be used for locating items, both moving and standing still objects, such as suitcases bags at airport conveyers, cars, or humans and any other object that need to be located.

The method for determining the distance is using a unique protocol, also denoted as Distance discovery Layer Protocol or RFPING protocol, between a pair of Bluetooth transceivers, over an existing Bluetooth RF link.

The following description relies on Bluetooth v2.1+EDR specification but can be upgraded to any future version of Bluetooth. Detailed description of the unique protocol is specified in Appendix-A.

The pair of Bluetooth transceivers includes a first Bluetooth transceiver of a monitoring device that serves as a master device and a second Bluetooth transceiver that belong to a monitored device that serves as a slave device. The pair of Bluetooth transceivers can establish a logic channel between themselves, for transmitting a unique protocol messages. By using these unique protocol messages, the devices can calculate the distance between them without changing the Bluetooth protocol.

The devices can be in the “golden range” as requested by the Bluetooth specification, but without knowing the power and RX gain of both devices, the distance between them can not be calculated. A RFPING protocol is implemented on both devices has the TX power and RX gain of the devices, such that the distance between them can be calculated.

For example, by using a unique command between the pair of Bluetooth devices, the first device can request the second device to send a RF echo ping. This added invited RFping, denoted RFping, will encapsulate the second device's RF transmission power and RF reception power and the time between the transmission of the request and the reply along with optional information of three dimension (3D) sum of movement and direction that can be measured by an accelerometer of the second device. The first Bluetooth device can calculate the distance between the pair of Bluetooth devices, by using a formula that takes into account at least part of the parameters: a transmission power of the first device, a reception power of the first device, a transmission power of the second device and a reception power of the second device.

A constants table converts a pair of values: [the second device's transmission power, the first device reception power] into a distance measured in different locations in real world scenarios, as open air, near airport luggage system and the like.

The values of the second device's transmission power and the first device reception power are normalize before being used, i.e. calculating the values to be in the same scale, So that the second device's transmission power minus the first device reception power in range zero will result zero.

The Distance between the pair of devices is=Range_Constant [<second device's transmission power>−<first device reception power>)]+Range_Constant [<first device's transmission power>−<second device reception power>] divide by 2.

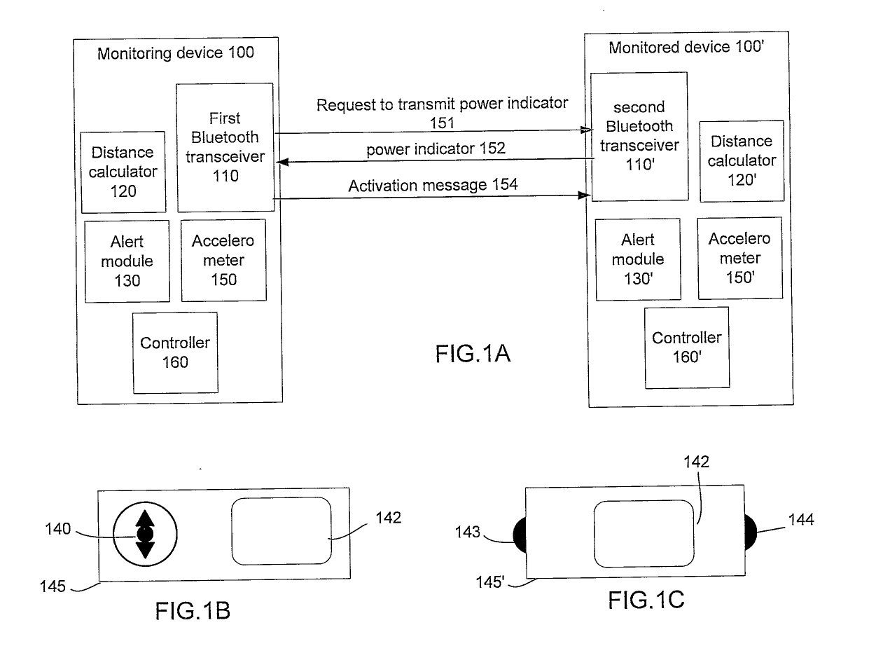

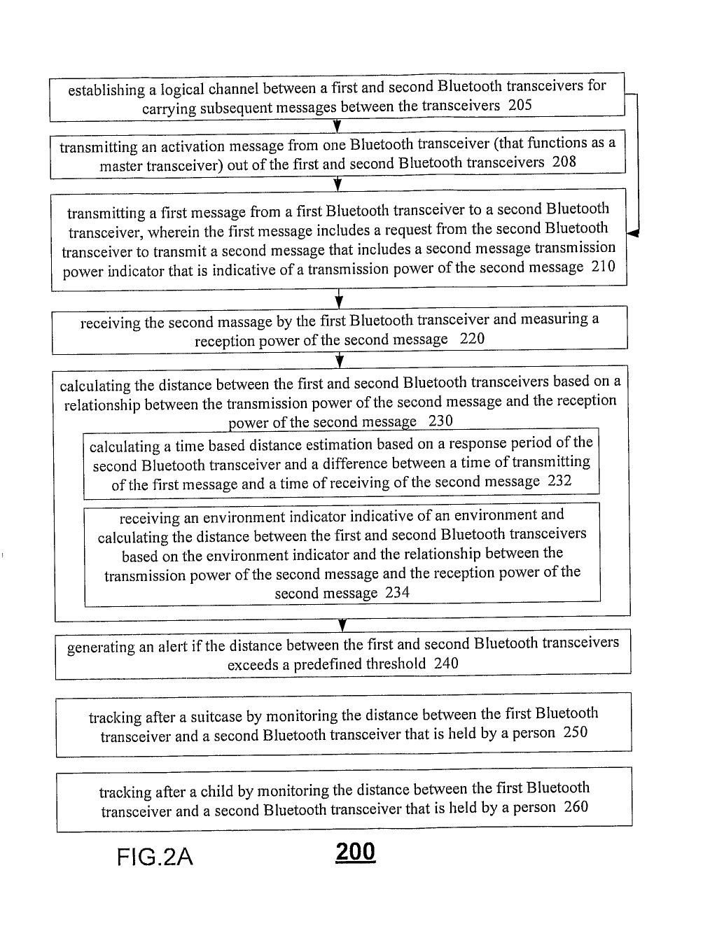

FIG. 1A illustrates a monitoring device 100 (also referred to as a first device) and a monitored device 100′ (also referred to as a second device). Each of monitoring device 100 and monitored device 100′ includes: a first Bluetooth transceiver 110 and a second Bluetooth transceiver 110′, respectively, for receiving and transmitting messages related to a distance determining protocol; a distance calculator 120 and 120′, respectively, for calculating a distance between first Bluetooth transceiver 110 and second Bluetooth transceiver 110′. In some embodiments monitored device 100′ may not include distance calculator 120; and a controller 160 that prevents the second Bluetooth transceiver from transmitting messages until the second Bluetooth transceiver is activated by an activation message transmitted from the first Bluetooth transceiver.

Monitoring devices 100 and monitored device 100′ establish a logic channel prior to any message exchange so that messages related to the distance determining protocol are transmitted over the logic channel.

First Bluetooth transceiver 110 can transmit, over the logic channel, a first message 151 that includes a request to transmit a second message 152 that includes a second message transmission power indicator that is indicative of a transmission power of the second message. Note that the transmission power of the second message (i.e. the transmission power that is included in the second message) corresponds to a power in which second Bluetooth transceiver 110′ transmitted the second message.

First message 151 can optionally include a first message transmission power indicator that will be used by device 100′ for a distance calculation. Note that the first message transmission power corresponds to a power in which first Bluetooth transceiver 110 transmitted the first message. Second Bluetooth transceiver 110′ can generate a distance estimate, based on the first message transmission power indicator, and second message 152 can include the distance estimate.

When second message 152 is received by first Bluetooth transceiver 110, the message is conveyed to distance calculator 120 that calculates the distance between the first and second Bluetooth transceivers 110,100′, based on the relationship between the second message transmission power (the power in which second Bluetooth transceiver 110′ transmitted the second message 151) and a second message reception power. Note that the second message reception power refers to the reception power in which second message 152 was received by first Bluetooth transceiver 110. Optionally, the calculations can be additionally based on the distance estimate, if included in second message 152.

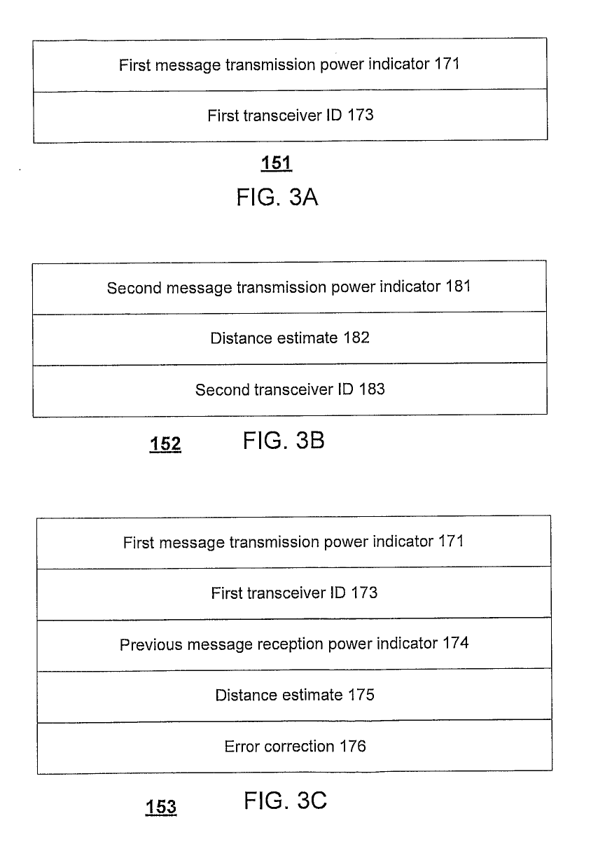

FIG. 3A illustrates first message 151 and FIG. 3B illustrates second message 152. Message 151 includes fields: first message transmission power indicator 171 and First transceiver ID 173. Both fields 171 and 172 are optional. Message 152 includes fields: second message transmission power indicator 181, distance estimate 182 and second transceiver ID 183. Fields 182 and 183 are optional. FIG. 3C illustrates an alternative message 153 that can be sent from one Bluetooth transceiver to a second Bluetooth transceiver. The differences between message 153 and message 151 are three additional fields: Previous message reception power indicator 174, Distance estimate 175 and Error correction 176.

The distance, calculated by distance calculator 120, can be additionally or alternatively based on time based distance estimation. The time based distance estimation is based on a response period of second Bluetooth transceiver 110′ and a difference between a time of transmitting of first message 151 and a time of receiving of second message 152. The distance between the pair of Bluetooth transceivers 110, 110′, is then calculated, based on the time based distance estimation and the reception power of the second message.

Distance calculator 120 can optionally base the distance calculation on an environment indicator in addition to the power indications. The distance indicator is indicative of the environment of the pair of monitoring devices, such as a crowded environment as in an airport or an open space in which the sight range between the devices is not blocked.

In case the environment indicator is used, multiple constant tables are built so as to converts the pair of values: [the second device's transmission power, the first device reception power] into a normalized distance, wherein each constant table corresponds to one type of environment.

According to an embodiment of the invention, monitoring device 100 can optionally include an alert module 130 for generating an alert if the distance between first and second Bluetooth transceivers, 110, 110′, exceeds a predefined threshold. For example, if a suitcase is stolen or a child is kidnapped or get lost, or in any other situation in which the monitored device is drawing away from the monitoring device, an alert will be raised. The alert module can use one or more alerting techniques, such as but not limited to the following techniques: (i) displaying the alert on a display 142 (FIG. 1B); (ii) generating vibrations; (iii) activating a speaker for a vocal alert and/or for providing vocal instructions regarding distance and direction of the monitored device; and (iv) opening an audio communication channel between the pair of devices, and activating a microphone and/or a speaker. For example: if monitored device 100′ is attached to a child, the parent that holds monitoring device 100 can hear the child and voices that surround the child. The audio communication channel can be uni-directional, in which case the speaker of the monitoring device provides audio that was received from the monitored device, or the audio communication channel can be bi-directional, in which case a microphone is activated and provides audio to be transmitted to the monitored device.

Monitored device 110′ can optionally include an alert module 130′ that is activated when the distance between the pair of devices, exceeds a predefined threshold. Alert module 130′ can be identical to alert module 130 or be different and may include at least one of: (i) opening an audio communication channel and activating a speaker and/or a microphone; (ii) activating an accelerometer that senses a 3D movement and direction and sending the 3D movement information, that includes distance and direction, to monitoring device 100; and (iii) generating an audio or a vocal alert, so as to grab an attention to the child that is being kidnapped or to the stolen suitcase.

The process of calculating the distance can be triggered by a multi purpose bottom 140 resides on a panel of monitoring device 100. FIG. 1B illustrates an example of a panel 145 of monitoring device 100 that includes a display 142 and a multi purpose bottom 140 that can be used for menu navigation: backward and forward menu navigation is achieved by pushing the lower and upper parts of multipurpose bottom 140, while a selection (“OK”) is achieved by pressing a central part of multipurpose bottom 140. FIG. 1C illustrates another example of a panel 145′ with two bottoms 143 and 144 that can be scrolled (for navigation) or pressed (for selection).

It is noted that monitored device 100′ is conveniently adapted to either fit within an item (such as a suitcase or other type of luggage), or to be detachably attached to an item (e.g. to an outer surface thereof). Monitoring device 100 is usually adapted to be carried (e.g. handheld) by a user, albeit in other implementation it may be integrated into another system (e.g. a car). It is further noted that monitoring device 100 may be integrated into a system which has other capabilities (e.g. monitoring device 100 may be integrated into a cellular phone or a PDA, and so forth).

Monitoring device 100 can be carried by the user and monitored device 100′ can be attached to the suitcase or other item that functions as a slave, according to an embodiment of the invention. In this embodiment second Bluetooth transceiver 110′ is prevented from transmitting messages until second Bluetooth transceiver 110′ is activated by an activation message 154 transmitted from first Bluetooth transceiver 110. Such activation is usually implemented by a coded RF transmission, or by an RF transmission that includes an activation code. It is noted that such activation is useful for meeting air security standards, that forbid any electronic transmission whatsoever on an airplane before the latter is safely landed and stopped. It is noted that other security means that prevent undesirable activation may be implemented, such as different kinds of sensors.

Activation message 154 can be transmitted by first Bluetooth transceiver 110 upon an initialization of monitoring device 100 (e.g. after switching on). Once activation message 154 is received by monitored device 100′, monitored device 100′ can start transmitting power information and the monitoring is available. Activation message 154 can also be triggered by a clock (timing activation) and or upon a movement detected by Accelerometer 150.

Monitored device 100′ will remain in an activated state until first Bluetooth transceiver 110 sends a de-activation message. The de-activation message can be sent automatically upon switching off monitoring device 100. When switching off monitored device 100′ without sending a de-activation message prior to the switching-off (e.g. without first switching off monitoring device 100), monitored device 100′ will enter a sleep mode but will retain the activation mode that was set prior to the switching-off, i.e. if the activation mode was set to activated-state, then monitored device 100′ will remain activated. This is important in case of unintentionally switching off monitored device 100′ or in case of a maliciousness switching off by a thief or a child kidnapper.

After monitored device 100′ is activated, the RFPING protocol messages will be transmitted between monitoring device 100 and monitored device 100′. This protocol will enforce monitored device 100′ to transmit in pre-define RF transmission power (or a power indicated by monitoring device 100). This way, knowing the transmission power of monitored device 100′ (and especially knowing that the latter is fixed in time, contrary to the situation in standard Bluetooth protocol for example) in a way monitoring device 100 can detect monitored device 100′ and conveniently also determine a distance between the pair of devices or at least calculate the changing in distance between the pair devices, in accordance with the change in the reception power.

It is noted that, according to an embodiment of the invention, the protocol used to communicate between devices 100′ and 100 is a modified Bluetooth protocol, which enables control on the transmission power in the way detailed above. It is noted that, according to an embodiment of the invention, at least one of devices 100′ and 100 includes a communication components such as Bluetooth transceivers 110 and 110′ that is a Bluetooth component that have been adapted to enable control of the transmission power in the way disclosed above.

Moreover, monitoring device 100 will conveniently transmit a unique encoded RF pulse to which monitored device 100′ will replay upon receive. Monitoring device 100 will revise the return pulse monitored device 100′ and will calculate the distance from monitored device 100′ by the time it takes from sending the pulse and receiving the respond pulse. This approach will overcome the difference in distance which RF signal reflection or absorption from other objects like metals, humans, walls and other suitcases etc.

According to an embodiment of the invention, at least one of devices 100′ and 100 includes a display, adapted to display information to a user (e.g. operational status of the devices, distance between the devices). According to an embodiment of the invention, at least one of devices 100′ and 100 includes other output interface. According to an embodiment of the invention, device 100 is adapted to issue an alarm if a distance between devices 100′ and 100 is increasing (e.g. the item located is being stolen).

According to an embodiment of the invention, devices 100′ and 100 are substantially identical, but only operate in different operational states (i.e. same hardware, and/or firmware and software, but selected to operate as locator or locatable). According to an embodiment of the invention, such device includes an interface for receiving operational state indication.

According to an embodiment of the invention, the active distance operational start range at 100 m (full range of a potential suitcase conveyer).

According to an embodiment of the invention, Bluetooth is used to measure distance with the RFPING protocol (controlling a transmission power of device 100′, even below/above the transmission power mandated by the Bluetooth protocol at a given situation).

According to an embodiment of the invention, an announcing message or a special tone is played on a hand held device—and/or at the luggage device, when the distance is shorter than a predefined threshold.

Conveniently, monitoring device 100 and monitored device 100′ includes a USB interface that can be used for a battery charged through the USB interface. The USB can be used for software download, localization files download (i.e. adaptation of language dependent files) or any other data download as well as uploading of information that was generated and stored in the devices.

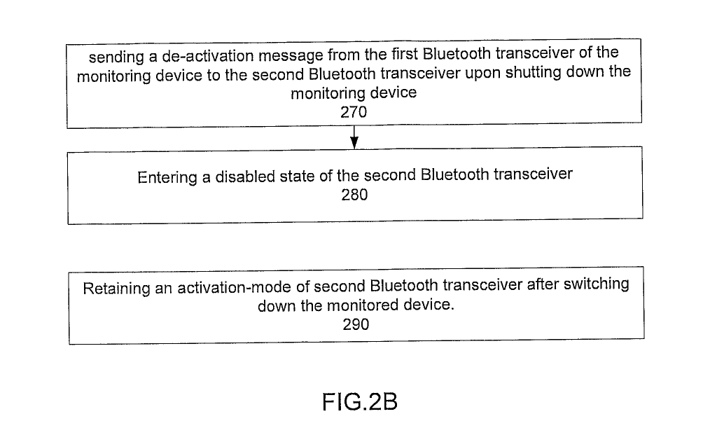

FIG. 2A illustrates a method 200 for determining a distance between a first and second Bluetooth transceivers of a monitoring device and a monitored device. Method 200 starts with stage 205 of establishing a logical channel between the first and second Bluetooth transceivers for carrying subsequent messages between the Bluetooth transceivers.

Stage 205 may be followed by stage 208 of transmitting an activation message from one Bluetooth transceiver (that functions as a master transceiver) out of the first and second Bluetooth transceivers. In this scenario, the other Bluetooth transceiver (that functions as a slave transceiver) is prevented from transmitting messages until it is activated by the activation message. In case that the transmission prevention is not used, stage 205 is followed by stage 210.

Stages 205 and 208 (establishing a logical channel and transmitting an activation message) can be activated after turning on the first and second device. The transmitting of the activation message can also be triggered by a clock (timing activation). The transmitting of the activation message can optionally be triggered by movement detection of the second device.

Stages 205 and 208 are followed by stage 210 of transmitting a first message from a first Bluetooth transceiver to a second Bluetooth transceiver, wherein the first message includes a request from the second Bluetooth transceiver to transmit a second message that includes a second message transmission power indicator that is indicative of a transmission power of the second message. Note that the transmission power of the second message (i.e. the transmission power that is included in the second message) corresponds to a power in which second Bluetooth transceiver 110′ transmitted the second message. The first message can optionally include a transmission power indicator that is indicative of a transmission power of the first Bluetooth transceiver. The messages can optionally include a Bluetooth transceiver identifier.

Stage 210 is followed by stage 220 of receiving the second massage by the first Bluetooth transceiver and measuring a reception power of the second message. The reception power of the second message refers to a power that was measured by first Bluetooth transceiver for the reception of the second message. The second message can optionally include a distance estimate generated by the second Bluetooth transceiver.

Stage 220 is followed by stage 230 of calculating the distance between the first and second Bluetooth transceivers based on a relationship between the transmission power of the second message and the reception power of the second message. If the second message includes a distance estimate, then stage 220 can include calculating the distance between the first and second Bluetooth transceivers based on the distance estimate, in addition to the relationship between the transmission power of the second message and the reception power of the second message.

Stage 230 can, optionally or alternatively, include stage 232 of calculating a time based distance estimation based on a response period of the second Bluetooth transceiver and a difference between a time of transmitting of the first message and a time of receiving of the second message. If stage 232 is included then the calculating of the distance can be based on the time based distance in addition or as alternative to the distance estimate and also based on a relationship between the transmission power of the second message and the reception power of the second message.

Stage 230 can optionally include stage 234 of receiving an environment indicator indicative of an environment and calculating the distance between the first and second Bluetooth transceivers based on the environment indicator and the relationship between the transmission power of the second message and the reception power of the second message. The environment indication can indicate whether the environment is an open space or a crowded environment.

Stage 230 may be followed by stage 240 of generating an alert if the distance between the first and second Bluetooth transceivers exceeds a predefined threshold. Stage 240 may include generating an audio or a vocal alert, displaying the alert on a display or any other alert indication.

Stage 240 may optionally include transmitting, by the second Bluetooth transceiver, distance and direction information and providing, by the first Bluetooth transceiver, vocal instructions regarding distance and direction of the second Bluetooth transceiver.

Stage 240 may optionally include opening an audio communication channel between the pair of devices, and activating a microphone and/or a speaker.

Method 200 may include a stage 250 of monitoring after the suitcase by monitoring the distance between the first Bluetooth transceiver that is attached to a suitcase and a second Bluetooth transceiver that is held by a person. The monitoring is based on the distance that is calculated in stage 230.

Method 200 may include a stage 260 of monitoring after a child by monitoring the distance between the first Bluetooth transceiver that is attached to the child and a second Bluetooth transceiver that is held by a person. The monitoring is based on the distance that is calculated in stage 230.

Method 200 includes a stage 270 of sending a de-activation message from the first Bluetooth transceiver of the monitoring device to the second Bluetooth transceiver (of the monitored device) upon shutting down the monitoring device.

Stage 270 is followed by stage 280 of entering a disabled-state of the second Bluetooth transceiver. After entering the disabled-state, second Bluetooth transceiver won't transmit until an activation message is received.

Method 200 can include stage 290 of retaining an activation-mode of the second Bluetooth transceiver after switching down the monitored device.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

### APPENDIX A—Distance discovery Protocol

The Distance discovery Layer Protocol (RFPING) is layered over the Baseband Protocol and resides in the data link layer. RFPING provides distance discovery-oriented and distance discovery services to upper layer protocols with protocol multiplexing capability, segmentation and reassembly operation, group abstractions. RFPING permits higher level protocols and applications to transmit and receive RFPING data packets up to 64 kilobytes in length.

Two link types are supported for the Baseband layer: Synchronous Distance discovery-Oriented (SRFPING) links and Asynchronous Distance discovery (ARFPING) links. SRFPING links send real-time Distance discovery traffic only by RFPING request. ARFPING links transmit RFPING traffic every few seconds without RFPING request.

RFPING supports several protocol functions such as Protocol Multiplexing. RFPING support protocol multiplexing because in some situation RFping respond is needed from group of devices.

RFPING General Operation
1. The RFPING layer is based on the concept of ‘channels’. Each one of the end-points of an RFPING channel is referred to by a channel identifier.
2. Channel Identifiers (CIDs) are local names representing a logical channel end-point on the device. Implementations are free to manage the CIDs in a manner best suited for that particular implementation, with the provision that the same CID is not reused as a local RFPING channel endpoint for multiple simultaneous RFPING channels between a local device and some remote device.
3. CID assignment is relative to a particular device and a device can assign CIDs independently from other devices (with the exception of certain reserved CIDs , such as the signaling channel).

Operation Between Devices
4. The distance discovery-oriented data channels represent a distance discovery between two devices, where a CID identifies each endpoint of the channel. The distance discovery channels restrict data flow to a single direction. These channels are used to support a channel ‘group’ where the CID on the source represents one or more remote devices. There are also a number of CIDs reserved for special purposes. The signaling channel is one example of a reserved channel. This channel is used to create and establish distance discovery-oriented data channels and to negotiate changes in the characteristics of these channels. Support for a signaling channel within an RFPING entity is mandatory. Another CID is reserved for all incoming distance discovery less data traffic.

Operation Between Layers
5. RFPING implementations follow the general architecture described here:
6. RFPING implementations transfer data between higher layer protocols and the lower layer protocol.
7. Each implementation also supports a set of signaling commands for use between RFPING implementations.

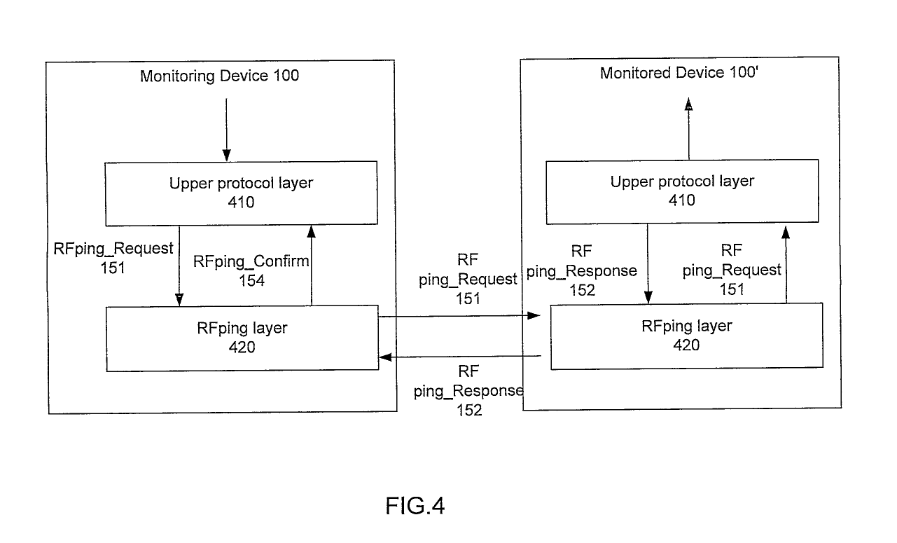

RFPING State Machine
8. This section describes the RFPING distance discovery-oriented channel state machine. The section defines the states, the events causing state transitions, and the actions to be performed in response to events. This state machine is only pertinent to bi-directional CIDs and is not representative of the signaling channel or the uni-directional channel.
9. FIG. 4 illustrates the events and actions performed by an implementation of the RFPING layer. Monitoring device 100 is the initiator of a RFPING request 151 and monitored device 100′ is the acceptor of RFPING. An application-level Client would both initiate and accept requests.
10. An upper protocol layer 410 communicates with RFPING layer 420, within the same device (vertical interface) by using the prefix of RFPING layer 420 offering the service to upper protocol layer 410. Upper protocol layer 410 initiates the session by sending RFPING request 151 to RFPING layer 420, which immediately replies with a message-RFPING confirm 154.
11. The interface between the same layer (horizontal interface) of two devices (e.g. monitoring device 100 and monitored device 100′) uses the RFPING protocol. RFPING layer 420 of monitoring device 100 sends RFPING request 151 to RFPING layer 420 of monitored device 100′. RFPING layer 420 of monitored device 100′ sends RFPING respond 152 to RFPING layer 420 of monitoring device 100.

Other RFPING Features
12. RFPING is packet-based but follows a communication model based on channels. A channel represents a data flow between RFPING entities in remote devices. Channels may be Synchronous Distance discovery -Oriented (SRFPING) links or Asynchronous Distance discovery (ARFPING) links. SRFPING links send real-time Distance discovery traffic only by RFPING request. ARFPING links transmit RFPING traffic every few seconds without RFPING request base on Configuration Parameter Options.

RFPING Signaling
13. Various signaling commands can be passed between two RFPING entities on remote devices. All signaling commands are sent to CID 0x0001 (the signaling channel). The RFPING implementation able to determine the Bluetooth address (BD_ADDR) of the device that sent the commands. Multiple commands may be sent in a single (RFPING). Commands take the form of Requests and Responses.
14. Configuration Parameter Options provides a mechanism for extending the ability to negotiate different distance discovery requirements. Options are transmitted in the form of information elements comprised an option type, an option length, and one or more option data fields. For example average of TX power over time, or average RX receive over time, Report above/below set “distance” etc.
15. Several services are offered by RFPING in terms of service primitives and parameters as follows:
15.1 My CID: unique ID per devices. Set by user or auto creates from Bluetooth address.
15.2 Group ID: ID which is the same to all devices need to responds to RFping in the same environment. For example: the two devices (100 and 100′) will share the same Group ID, which is added to the Bluetooth (BT) address. Note that this field is different than the BT Paring Key used by the Bluetooth standard (0000 1111 8888).
15.3 Target ID: the target devices ID which has to respond to this RFping. Zero mean all devices with the same “Group ID” has to responds.
15.4 Rawest ID: setup, configure, disconnect, etc.
15.5 Configuration Parameter: mode of operational. As Synchronous Distance discovery -Oriented (SRFPING) links or Asynchronous Distance discovery (ARFPING) links, or other command to set devices behavior
15.6 My Time: the clock time.
15.7 My TX power: The setting level of Bluetooth RF TX amplifier (Transistor)
15.8 My RX receive: The setting level of Bluetooth RF RX amplifier (Receiver)
15.9 My constant RX to TX: Time takes from receive RFping command until respond.
15.10 My distance discover: the last distance discover from me-to you. You is the other Bluetooth device.
15.10.4.1 More Parameter: setting parameters.
   More Fields: more command and setting.

What is claimed is:

1. A method for determining a distance between a pair of Bluetooth transceivers, the method comprises:
transmitting a first message from a first Bluetooth transceiver to a second Bluetooth transceiver, wherein the first message comprises a request from the second Bluetooth transceiver to transmit a second message that comprises a second message transmission power indicator that is indicative of a transmission power of the second message;
receiving the second massage by the first Bluetooth transceiver and measuring a reception power of the second message; and
calculating the distance between the first and second Bluetooth transceivers based on a relationship between the transmission power of the second message and the reception power of the second message.

2. The method according to claim 1, comprising transmitting the first massage over a logic channel that is established between the first and second Bluetooth transceivers.

3. The method according to claim 1, comprising transmitting a first message that comprises a first message transmission power indicator that is indicative of a transmission power of the first message.

4. The method according to claim 1, comprising:
receiving a second message that comprises a distance estimate generated by the second Bluetooth transceiver; and
calculating the distance between the first and second Bluetooth transceivers based on the distance estimate and based on the relationship between the transmission power of the second message and the reception power of the second message.

5. The method according to claim 1, comprising calculating a time based distance estimation based on an response period of the second Bluetooth transceiver and a difference between a time of transmitting of the first message and a time of receiving of the second message.

6. The method according to claim 5, comprising calculating the distance between the first and second Bluetooth transceivers based on the time based distance estimation and based on the relationship between the transmission power of the second message and the reception power of the second message.

7. The method according to claim 6, comprising:
receiving a second message that comprises a distance estimate generated by the second Bluetooth transceiver; and
calculating the distance between the first and second Bluetooth transceivers based on the time based distance estimation, the distance estimate and based on the relationship between the transmission power of the second message and the reception power of the second message.

8. The method according to claim 1, further comprising:
receiving an environment indicator indicative of an environment of the first and second Bluetooth transceivers; and
calculating the distance between the first and second Bluetooth transceivers based on the environment indicator and the relationship between the transmission power of the second message and the reception power of the second message.

9. The method according to claim 8 wherein the environment indicator indicates whether the environment is an open space or a crowded environment.

10. The method according to claim 1, comprising preventing one Bluetooth transceiver out of the first and second Bluetooth transceivers from transmitting messages until the one Bluetooth transceiver is activated by an activation message transmitted from another Bluetooth transceiver out of the first and second Bluetooth transceivers.

11. The method according to claim 1, comprising transmitting the first message that comprises a first Bluetooth transceiver identifier.

12. The method according to claim 1, comprising generating an alert if the distance between the first and second Bluetooth transceivers exceeds a predefined threshold.

13. The method according to claim 1, wherein the first Bluetooth transceiver is connected to a suitcase, wherein the method comprises monitoring after the suitcase by monitoring the distance between the first Bluetooth transceiver and a second Bluetooth transceiver that is held by a person.

14. The method according to claim 1, wherein the first Bluetooth transceiver is attached to a child, wherein the method comprises monitoring after the child by monitoring the distance between the first Bluetooth transceiver and a second Bluetooth transceiver that is held by a person.

15. A monitoring device, comprising:
a first Bluetooth transceiver, for transmitting a first message to a second Bluetooth transceiver, wherein the first message comprises a request from the second Bluetooth transceiver to transmit a second message that comprises a second message transmission power indicator that is indicative of a transmission power of the second message; and for receiving the second massage by the first Bluetooth transceiver and measuring a reception power of the second message; and
a distance calculator for calculating the distance between the first and second Bluetooth transceivers based on a relationship between the transmission power of the second message and the reception power of the second message.

16. The monitoring device according to claim 15, wherein the first Bluetooth transceiver is configured to establish a logic channel with the second Bluetooth transceiver and to transmit the first massage over the logic channel.

17. The monitoring device according to claim 15, wherein the wherein the first Bluetooth transceiver is configured to transmit a first message that comprises a first message transmission power indicator that is indicative of a transmission power of the first message.

18. The monitoring device according to claim 15, wherein the first Bluetooth transceiver is configured to receive a second message that comprises a distance estimate generated by the second Bluetooth transceiver and, wherein the distance calculator is configured to calculate the distance between the first and second Bluetooth transceivers based on the distance estimate and based on the relationship between the transmission power of the second message and the reception power of the second message.

19. The monitoring device according to claim 15, wherein the distance calculator is configured to calculate a time based distance estimation based on a response period of the second Bluetooth transceiver and a difference between a time of transmitting of the first message and a time of receiving of the second message.

20. The monitoring device according to claim 19, wherein the distance calculator is configured to calculate the distance between the first and second Bluetooth transceivers based on the time based distance estimation and based on the relationship between the transmission power of the second message and the reception power of the second message.

21. The monitoring device according to claim 20, wherein the first Bluetooth transceiver is configured to receive a second message that comprises a distance estimate generated by the second Bluetooth transceiver; and wherein the distance calculator is configured to calculate the distance between the first and second Bluetooth transceivers based on the time based distance estimation, the distance estimate and based on the relationship between the transmission power of the second message and the reception power of the second message

22. The monitoring device according to claim 15, wherein first Bluetooth transceiver is configured to receive an environment indicator indicative of an environment of the first and second Bluetooth transceivers; and wherein the distance calculator is configured to calculate the distance between the first and second Bluetooth transceivers based on the environment indicator and the relationship between the transmission power of the second message and the reception power of the second message.

23. The monitoring device according to claim 22 wherein the environment indicator indicates whether the environment is an open space or a crowded environment.

24. The monitoring device according to claim 15, comprising a controller that prevents the second Bluetooth transceiver from transmitting messages until the second Bluetooth transceiver is activated by an activation message transmitted from the first Bluetooth transceiver.

25. The monitoring device according to claim 15, comprising an alert module for generating an alert if the distance between the first and second Bluetooth transceivers exceeds a predefined threshold.

26. A system, comprising a first device and a second device;
wherein the first device comprises:
a first Bluetooth transceiver, for transmitting a first message to a second Bluetooth transceiver, wherein the first message comprises a request from the second Bluetooth transceiver to transmit a second message that comprises a second message transmission power indicator that is indicative of a transmission power of the second message; and for receiving the second massage by the first Bluetooth transceiver and measuring a reception power of the second message; and
a distance calculator for calculating the distance between the first and second Bluetooth transceivers based on a relationship between the transmission power of the second message and the reception power of the second message;
wherein the second device comprises:
a second Bluetooth transceiver, for transmitting the second message to the first Bluetooth transceiver, wherein the second message comprises the second message transmission power indicator that is indicative of the transmission power of the second message.

27. The method of claim 1 further comprises retaining an activation-mode of the second Bluetooth transceiver after switching down the second Bluetooth transceiver.

28. The method of claim 1, comprising transmitting, by the first Bluetooth. transceiver, an activation message that is triggered by movement detection.

29. The method of claim 1, comprising transmitting an activation message that is triggered by a clock.

30. The system of claim 26, wherein the second device retains an activation-mode of the second Bluetooth transceiver after switching off the second device.

31. The method of claim 12, wherein the generating of the alert comprises generating a vocal alert.

32. The method of claim 12, wherein the generating of the alert comprises transmitting, by the second Bluetooth transceiver, distance and direction information and providing, by the first Bluetooth transceiver, vocal instructions regarding distance and direction of the second Bluetooth transceiver.

33. The method of claim 12, wherein generating of the alert comprises opening an audio communication channel between the first Bluetooth transceiver and the second Bluetooth transceiver.
